(19) United States
(12) Patent Application Publication
(10) Pub. No.: US 2008/0014337 A1
(43) Pub. Date: Jan. 17, 2008

(54) Method for manufacturing magnetic recording media

(75) Inventors: Masatoshi Sakurai, Tokyo (JP); Yoshiyuki Kamata, Tokyo (JP); Satoshi Shirotori, Fuchu-shi (JP); Akira Kikitsu, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/822,250

(22) Filed: Jul. 3, 2007

(30) Foreign Application Priority Data
Jul. 3, 2006 (JP) 2006-183693

(51) Int. Cl. B05D 5/12; B05D 3/00; B05D 3/12

(52) U.S. Cl. 427/127; 427/532; 427/355

(57) ABSTRACT

According to one embodiment, there is provided a method for manufacturing a magnetic recording media, including forming a magnetic film on a substrate and coating a resist on the magnetic film, imprinting a stamper on the resist to transfer patterns of recesses and protrusions to the resist, and removing the stamper and then performing ion milling to process the magnetic film with resist residues remained in recesses in the patterned resist to form magnetic patterns.

### CROSS-REFERENCE TO RELATED APPLICATIONS

This application is based upon and claims the benefit of priority from Japanese Patent Application No. 2006-183693, filed Jul. 3, 2006, the entire contents of which are incorporated herein by reference.

### BACKGROUND

1. Field

One embodiment of the present invention relates to a method for manufacturing a magnetic recording media, and in particular, to a method for manufacturing a patterned media such as a discrete track recording media.

2. Description of the Related Art

In recent years, much attention has been paid to patterned media such as discrete track recording media (DTR media) in which adjacent recording tracks are separated from each other by a nonmagnetic material to reduce magnetic interference between the adjacent tracks for the purpose of further increasing density of the magnetic recording media. In manufacturing such discrete track recording media, costs can be reduced by using an imprinting method with a stamper to form not only magnetic patterns constituting recording tracks but also magnetic patterns corresponding to servo signals, because this method eliminates the need for servo track writing.

A typical known imprinting method is as follows (see U.S. Pat. No. 5,772,905). First, polymethylmethacrylate (PMMA), a thermoplastic resin, is coated on a silicon substrate as a resist. Heat cycle nano-imprinting is then performed using a stamper to transfer patterns of the stamper to the resist. The stamper is removed, and residues remaining in recesses between resist patterns are removed by oxygen RIE (reactive ion etching) to expose a silicon surface. Subsequently, etching is performed using the resist patterns as a mask to form protruded patterns of silicon.

The conventional method requires the step of removing the residues remaining in the recesses between the resist patterns. This is to avoid a possible disadvantage that imprinting varies the resulting thickness of the resist residues which adversely affects subsequent uniform etching.

However, the manufacturing costs of the patterned media can be reduced by eliminating the need for the step of removing resist residues.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A, 1B, 1C, 1D, and 1E are cross-sectional views showing a method for manufacturing a patterned magnetic recording media according to an example of the present invention;

FIG. 2 is a cross-sectional view showing the state of a resist during imprinting;

FIG. 3 is a plan view of a magnetic recording media according to an embodiment of the present invention;

FIG. 4 is a schematic diagram showing areas of the magnetic recording media according to the embodiment of the present invention;

FIG. 5 is a plan view showing patterns in a servo area;

FIG. 6 is a diagram illustrating the occupation area rate of recesses in each area of a stamper surface;

FIGS. 7A, 7B, 7C, 7D, 7E, and 7F are cross-sectional views showing a method for manufacturing a patterned magnetic recording media in Comparative Example 1; and

FIGS. 8A, 8B, 8C, 8D, and 8E are cross-sectional views showing a method for manufacturing a patterned magnetic recording media in Comparative Example 2.

### DETAILED DESCRIPTION

Various embodiments according to the invention will be described hereinafter with reference to the accompanying drawings. In general, according to one embodiment of the present invention, there is provided a method for manufacturing a magnetic recording media, comprising: forming a magnetic film on a substrate and coating a resist on the magnetic film; imprinting a stamper on the resist to transfer patterns of recesses and protrusions to the resist; and removing the stamper and then performing ion milling to process the magnetic film with resist residues remained in recesses in the patterned resist to form magnetic patterns.

The present invention will be described below on the basis of an example.

### EXAMPLE

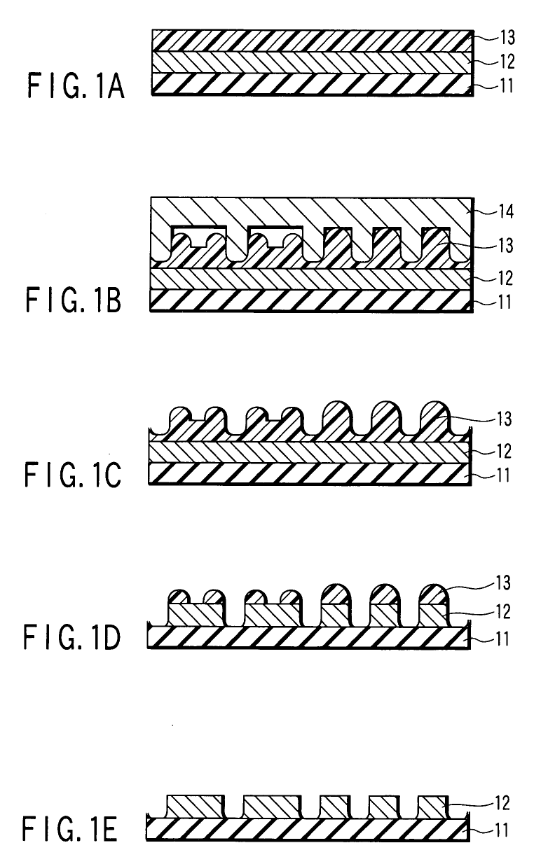

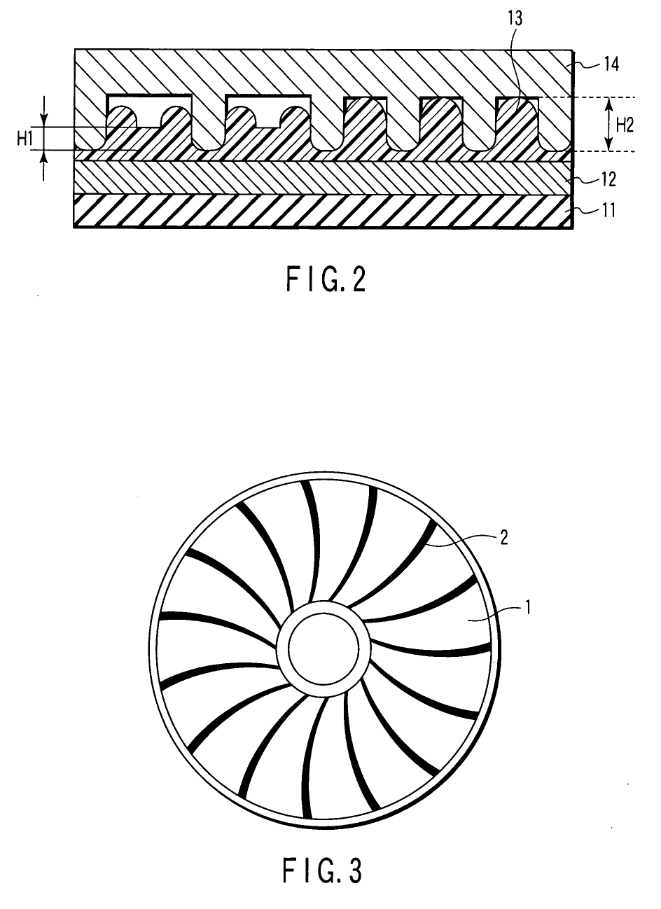

With reference to cross-sectional views shown in FIGS. 1A, 1B, 1C, 1D, and 1E, description will be given of a method for manufacturing a patterned magnetic recording media according to the example of the present invention.

As shown in FIG. 1A, a magnetic film 12 is deposited on a substrate 11, and a resist 13 is coated on the magnetic film 12.

In the present example, a perpendicular recording media is produced which has a substrate, and a soft underlayer, a perpendicular recording layer, and a protective layer which are formed on the substrate. However, for convenience of description, the structure of the media is simplified in the figures. That is, in FIG. 1A, the substrate 11 includes a substrate and a soft underlayer. The magnetic film 12 includes a perpendicular layer and a protective layer.

The substrate may be, for example, a glass substrate, an Al-based alloy substrate, a ceramic substrate, a carbon substrate, a Si single-crystal substrate having an oxide surface, and any of these substrates plated with NiP.

A material for the soft underlayer contains Fe, Ni, or Co. More specifically, examples of the soft underlayer include a FeCo-based alloy such as FeCo and FeCoV, an FeNi-based alloy such as FeNi, FeNiMo, FeNiCr, and FeNiSi, an FeAl-based alloy and an FeSi-based alloy such as FeAl, FeAlSi, FeAlSiCr, FeAlSiTiRu, and FeAlO, an FeTa-based alloy such as FeTa, FeTaC, and FeTaN, and a FeZr-based alloy such as FeZrN.

A material for the perpendicular recording layer mainly contains Co and also contains at least Pt and further an oxide. A particularly preferred oxide is silicon oxide or titanium oxide.

The protective layer is intended to prevent the perpendicular recording layer from being corroded and to prevent the surface of the media from being damaged when a magnetic head comes into contact with the media surface. A material for the protective layer includes, for example, C, SiO₂, and ZrO₂.

In the present example, a soft underlayer having a thickness of 120 nm, a perpendicular recording layer having a thickness of 20 nm, and a protective layer having a thickness of 4 nm are successively deposited on a glass substrate.

The resist 13 is coated on the magnetic film 12 by spin coating. The resist may be a common novolak-based photoresist. In the present example, a common photoresist S1818 (available from Shipley Co.) is coated on the magnetic film 12 as the resist 13 to a thickness of about 40 nm. Spin-on-glass (SOG) may be used as a resist.

As shown in FIG. 1B, patterns of recesses and protrusions are formed on the resist 13 by imprinting. The imprinting is a process of pressing a stamper 14 with patterns of recesses and protrusions against a flat surface of the resist 13 to transfer the patterns of recesses and protrusions on the surface of the stamper 14 to the resist 13. Examples of a material for the stamper include, but are not limited thereto, metal such as Ni, Ti, and Al and their alloys.

The process of manufacturing a stamper is divided into pattern drawing, development, electroplating, and finishing. The pattern drawing includes installing a master on which a resist has been coated, in a master-rotating electron-beam lithography apparatus and exposing areas on the master corresponding to areas on a media in which a nonmagnetic material is embedded, from the inner periphery to outer periphery of the master. The resist is then developed, and the master is subjected to reactive ion etching (RIE) or the like to form patterns of recesses and protrusions on the master. The surface of the master is made conductive and then electroplated with Ni. The Ni film is released, and the master is punched out at an inner diameter and an outer diameter to manufacture a disk-shaped Ni stamper. On the stamper, the areas on the media corresponding to the nonmagnetic material constitute protrusions.

In the present example, after the imprinting, resist residues remained in the recesses in the resist 13 have an almost constant thickness in all the areas as described below in detail. This structure can be obtained by setting the thickness of the resist 13 smaller than the depth of the recesses in the stamper 14.

Specifically, the stamper 14 having recesses with a depth of 50 nm is pressed to the resist 13 with a thickness of 40 nm coated on the magnetic film, at 2,000 bar for 60 seconds to transfer the patterns of recesses and protrusions to the resist 13. The imprinting causes the protrusions of the stamper 15 to be pressed into the resist 13 by about 25 nm.

As shown in FIG. 1C, the stamper 14 is released from the resist 13 using vacuum tweezers. The resist 13 to which the patterns of recesses and protrusions have been transferred is thus formed on the surface of the substrate 11.

As shown in FIG. 1D, with resist residues remained in the recesses between the resist patterns 13, the magnetic film 12 is processed by Ar ion milling using the resist patterns 13 as a mask to form magnetic patterns.

As shown in FIG. 1E, the remained resist patterns 13 are stripped. If the resist is a common photoresist, the resist patterns 13 can be easily stripped by an oxygen plasma treatment. In the present example, an oxygen ashing apparatus is used to strip the resist under 1 Torr at 400 W for 5 minutes. In this case, the carbon protective film formed on the surface of the perpendicular recording layer is also removed. A resist made of SOG is stripped by RIE using fluorine-based gas.

Moreover, although not shown, the following steps are carried out to manufacture a magnetic recording media. After the resist is stripped, a filling layer of a nonmagnetic material is formed in the recesses between the magnetic patterns. The nonmagnetic material can be selected from oxides such as SiO₂, TiOₓ, SiO₂, and Al₂O₃, nitrides such as Si₃N₄, AlN, and TiN, carbides such as TiC, borides such as BN, and a simple substance such as C and Si.

Then, the filling layer is etched back to expose the perpendicular recording film. After the etch-back, surface roughness (Ra) is made 0.6 nm. The etch-back is preferably performed by Ar ion milling, but is not particularly limited thereto. In the present example, ion milling is performed at an acceleration voltage of 400 V and an ion incidence angle of 30°.

Then, a carbon protective film is formed on the surface. The carbon protective film is desirably formed by chemical vapor deposition (CVD) so as to improve the coverage of the recesses and protrusions. Alternatively, the carbon protective film may be formed by sputtering or vacuum evaporation. In the present example, the carbon protective film with a thickness about 4 nm is formed by CVD.

A lubricant is generally coated on the protective layer. The lubricant may be, for example, perfluoropolyether, fluorinated alcohol, or fluorinated carboxylic acid.

The above steps enable patterned media to be manufactured. In the present example, although a step of removing resist residues is not performed after imprinting, that is, the present example eliminates one etching step compared with a conventional method, appropriate magnetic patterns can be formed.

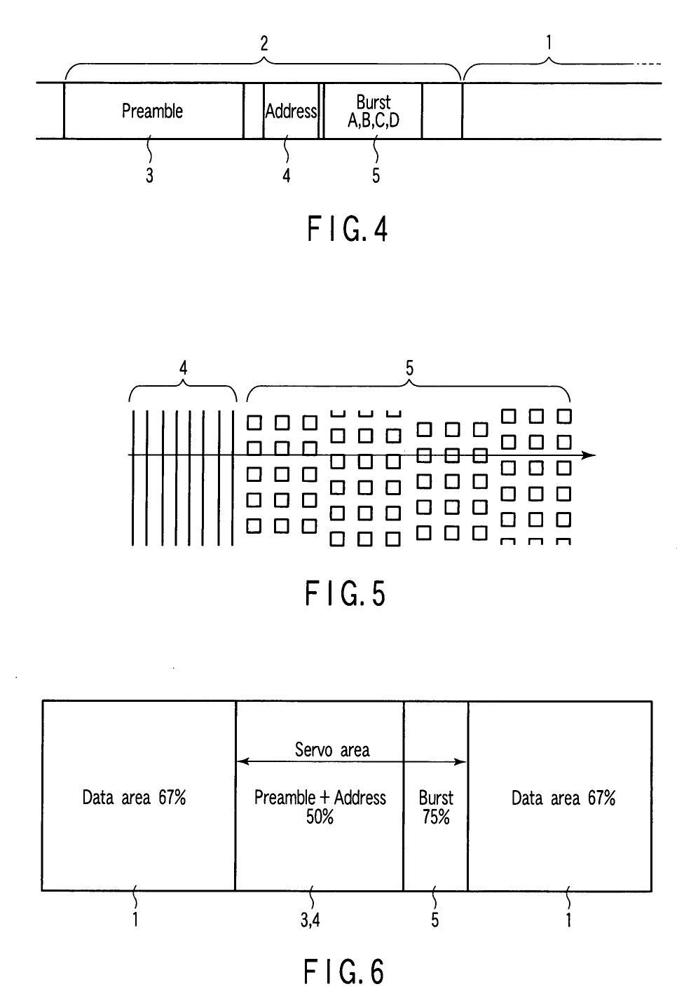

Now, with reference to FIGS. 2 to 6, a detailed description will be given of a method for manufacturing a magnetic recording media according to an embodiment of the present invention. FIG. 2 is a cross-sectional view showing a state of the resist during imprinting and corresponds to FIG. 1B. FIG. 3 is a plan view of a magnetic recording media according to the embodiment of the present invention. FIG. 4 is a schematic diagram showing the areas of the magnetic recording media according to the embodiment of the present invention. FIG. 5 is a plan view showing patterns in a servo area. FIG. 6 is a diagram illustrating the ratio of the areas occupied by recesses in the areas on a stamper surface.

First, with reference to FIG. 3, description will be given of the plan view of the magnetic recording media according to the embodiment of the present invention. The surface of the magnetic recording media is configured so that data areas 1 and servo areas 2 are alternately arranged along a circumferential direction.

User data is recorded in the data areas 1. In the data areas 1 in the DTR media, protruded magnetic patterns are formed concentrically at a constant track pitch Tp through a filling layer filled in recesses. The data areas 1 are separated from one another in the circumferential direction by the servo areas 2 so as to form sectors. Although FIG. 3 shows 15 servo sectors, 100 or more servo sectors are actually provided.

Magnetic patterns for head positioning are formed in the servo areas 2. The servo areas 2 are formed along a radial direction of the media like circular arcs corresponding to a locus of a head slider. Each of the servo areas 2 is formed so that its circumferential length increases in proportion to its radial position.

With reference to FIG. 4, description will be given of the arrangement of the servo area and data area on one track. When the media is installed in a drive, the head passes from the left to right of FIG. 4. As shown in FIG. 4, the servo area 2 includes a preamble portion 3, an address portion 4, and a burst portion 5. Each servo area 2 is located in front of the corresponding data area 1. As described above, the servo areas 2 and the data areas 1 are alternately arranged. FIG. 5 shows patterns in the address portion 4 and burst portion 5 in the servo area.

The preamble portion allows a PLL process or an AGC process to be executed to deal with time lag caused by the decentered rotation of the media. The PLL process synchronizes clocks for servo signal readout and the AGC process maintains appropriate signal readout amplitude. The preamble portion includes patterns that a magnetic material and a nonmagnetic material are repeatedly arranged in the circumferential direction almost like circular radiations without being separated in the radial direction. The ratio of the magnetic material to the nonmagnetic material is almost 1:1, that is, the occupation area rate of the magnetic patterns is about 50%. The circumferential repetition period varies in proportion to radial distance but is equal to or shorter than a visual light wavelength even at the outermost circumference. Thus, like the data areas, the servo areas cannot be easily identified by optical diffraction.

The address portion has servo signal recognition codes called servo marks, sector data, cylinder data, and the like formed at the same pitch as the circumferential pitch of the preamble portion by means of Manchester codes. In particular, the cylinder data have such patterns that vary among servo tracks. Thus, in order to reduce address misreading errors during a seek operation, the cylinder data are converted into so-called gray codes which minimize a change from the adjacent track, and the resulting codes are further converted into Manchester codes before recording. The occupation area rate of the magnetic patterns in this area is also about 50%.

The burst portion is an off-track detecting area used to detect an off-track amount of a cylinder address with respect to the on-track state. The burst portion is provided with four types of marks called A burst, B burst, C burst, and D burst and having respective pattern phases shifted from one another in the radial direction. Each of the bursts has a plurality of marks arranged at the same pitch as that of the preamble portion in the circumferential direction. The radial period of the bursts is proportional to the period of a variation in address pattern, in other words, to a servo track period. In the present example, for each burst, 10 periods of patterns are formed in the circumferential direction, and each burst is repeated at a period that is double the servo track period in the radial direction. Thus, the occupation area rate of the magnetic patterns in the ABCD bursts is about 75%. The mark shape is to be formed basically a square and precisely a parallelogram that is adopted taking a possible skew angle during head access into account. However, the marks are actually slightly rounded depending on machining performance such as stamper machining accuracy or transfer formation. The marks are formed as a nonmagnetic material. Although not described in detail, the principle of position detection based on the burst portion is such that the amplitude values of readout signals from the ABCD burst portions are arithmetically averaged to calculate an off-track amount.

The present example adopts the ABCD burst patterns. However, well-known phase difference servo patterns may be arranged as off-track amount detecting means. For the phase difference servo, the occupation area rate of the magnetic patterns is about 50%.

The patterns in the servo area have been described. In the stamper used to produce the DTR media, the occupation area rate of the recesses is 67% in the data area, 50% in the preamble portion, 50% in the address portion, and 75% in the ABCD burst (50% for the phase different servo patterns). FIG. 6 shows the occupation area rate of the recesses in each area of the stamper.

FIG. 2 shows the state of the resist observed when imprinting is performed using the above stamper. The left of FIG. 2 shows the data area (stamper recesses: 67%). The right of FIG. 2 shows the preamble portion (stamper recesses: 50%).

In the data area shown in the left of FIG. 2, those parts of the resist which are pressed by the stamper protrusions during imprinting are moved to stamper recesses so that the resist thickness is increased at the rims of stamper recesses. The resulting shape of the resist pattern in the stamper recesses is such that thickness increases at the rim but does not significantly change in the center. Thus, in the data area shown in the left of FIG. 2, the resist pattern is formed so as to be raised at the rim and to be thin in the center.

On the other hand, in the preamble portion shown in the right of FIG. 2, owing to the lower rate of the stamper recesses, those parts of the resist which are pressed by the stamper protrusions during imprinting are moved to stamper recesses, and the resist flows into each stamper recess from its peripheries and further to its center. This increases the resist thickness of the entire area of the stamper recess.

Thus, shapes of the recesses and protrusions of the resist patterns vary between the right and left of FIG. 2 depending on the area rate of the stamper recesses. The relationship between the minimum difference H1 in the height of the resist pattern in the data area and the minimum difference H2 in the height of the resist pattern in the preamble portion is H1<H2. That is, the difference in the height of the resist pattern in the data area in the right of FIG. 2 is smaller than that in the preamble portion in the right of FIG. 2. The difference in the height of the resist pattern corresponds to a mask thickness during subsequent etching. The etching is performed under conditions under which a mask having a thickness corresponding to the difference in the height of the resist pattern withstands processing.

In the present embodiment, the stamper with the recesses with a depth of (the protrusions with the height of) 50 nm is pressed to the resist with a thickness of 40 nm and pushed into the resist by 25 nm. As a result, in the left of FIG. 2, corresponding to the data area, the difference in the height of the resist pattern is made 25 nm. On the other hand, in the right of FIG. 2, corresponding to the preamble portion, the difference in the height of the resist pattern is made 50 nm, which corresponds to the height of the stamper protrusions.

In this case, the difference in the height of the resist pattern is measured sufficiently away from the wall surface of the stamper. This is because the surface tension of the resist causes the resist patterns to be rounded in the vicinity of the wall surface of the stamper.

On the other hand, in the present example, the resist thickness is smaller than the depth of the stamper recesses. Consequently, the depth by which the stamper protrusions are pushed into the resist is constant regardless of different occupation area rates of the stamper recesses. Thus, after imprinting, the thicknesses of the resist remained under the stamper protrusions, that is, the thicknesses of resist residues, are same between the right and left of FIG. 2. The thicknesses of the resist residues in the present example are made 15 nm in both the right and left of FIG. 2.

If the thicknesses of the resist residues are equal, it makes possible to process the resist residues and the magnetic film in a single etching step without using a step of removing the resist residues as in the prior art. Thus, magnetic patterns of a uniform height can be formed. That is, since the thicknesses of the resist residues remained in the recesses are equal in all the areas, the resist residues are simultaneously removed in all the areas. Subsequently, the magnetic film is simultaneously etched in all the areas. Therefore, the method according to the present example enables the manufacture of patterned media such as the discrete track recording media at reduced costs.

As described above, in order to make the thicknesses of the resist residues in areas with different occupation area rates of the stamper recesses constant, it is effective to reduce the resist thickness below the depth of the stamper recesses. That is, once the resist is thinned to some degree during imprinting, the stamper can no longer be pushed into the resist. This equalizes the thicknesses of the resist residues in all the areas. Strictly speaking, in order to make the thicknesses of the resist residues constant, it is necessary to take the effect of the viscosity of resist during imprinting and the patterns of recesses and protrusions of the stamper into account. However, effects due to these factors are not significant.

On the other hand, if the resist thickness is sufficiently larger than the depth of the stamper recesses, the stamper is pushed into the resist until the stamper recesses are almost filled with the resist. This equalizes the differences in the height of the resist pattern in all the areas, while varying the thicknesses of the resist residues under the stamper protrusions. If the thicknesses of the resist residues are made different, the etching depths of the magnetic film during the subsequent etching step are varied depending on the areas. This makes it difficult to form magnetic patterns of a uniform height.

### Comparative Example 1

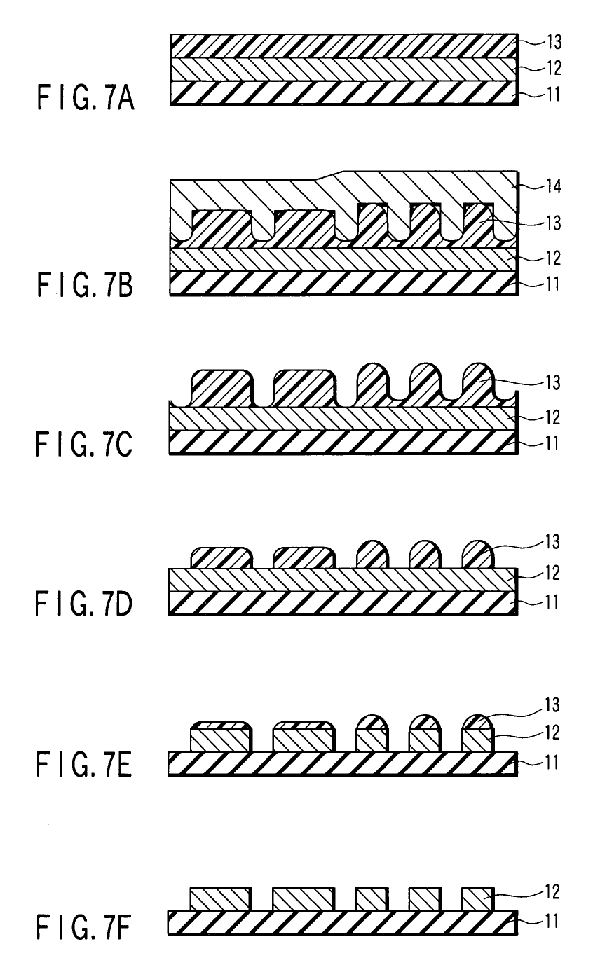

With reference to FIGS. 7A, 7B, 7C, 7D, 7E, and 7F, description will be given of a conventional method for manufacturing a patterned magnetic recording media, including a step of removing resist residues.

As shown in FIG. 7A, the magnetic film 12 is deposited on the substrate 11, and the resist 13 is coated on the magnetic film 12. In Comparative Example 1, the thickness of the resist 13 is set to 70 nm.

As shown in FIG. 7B, patterns of recesses and protrusions are formed on the resist 13 by imprinting. The depth of the recesses in the stamper 14 is the same as that in the example, i.e., 50 nm. At this time, the stamper recesses are filled with the resist deep down to their bottom in both the left and right areas in FIG. 7B, which have different occupation area rates of the stamper recesses. Subsequently, the stamper 13 is removed as shown in FIG. 7C. As a result, the equal difference in the height of the resist patterns, corresponding to the depth of the stamper recesses, is observed in both the left and right of FIG. 7B. On the other hand, the thickness of the resist residues under the stamper protrusions is 37 nm in the left of FIG. 7C and 45 nm in the right of FIG. 7C. The cause of the difference in thicknesses of the resist residues after imprinting is that the depth of the stamper recesses, 50 nm, is smaller than the resist thickness, 70 nm.

As shown in FIG. 7D, the resist residues are removed from the recesses to suppress the influence of the difference in the thicknesses of the resist residues. The removal of the resist residues is preferably performed by a method providing a high etching rate for the resist and a low etching rate for the magnetic film. In this case, the resist residues are removed by oxygen gas RIE (reactive ion etching). Etching is performed under conditions capable of removing the resist residues at a maximum thickness of 45 nm. Then, after the resist residue removal, the height of the resist mask is 40 nm in the left of FIG. 7D and 50 nm in the right of FIG. 7D.

Subsequently, as is the case with Example 1, the magnetic film is etched (7E) and the resist is stripped (7F) to obtain a patterned media.

For this patterned media, the shape of the magnetic patterns and the characteristics of the media are almost the same as those in Example 1. However, Comparative Example 1 disadvantageously requires the step of removing the resist residues, in other words, requires one more step than Example 1.

### Comparative Example 2

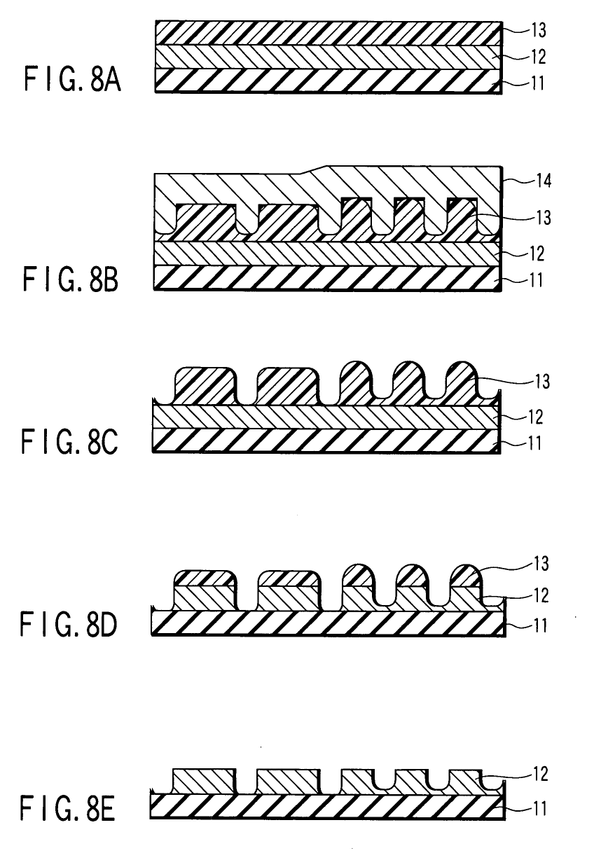

As shown in FIGS. 8A, 8B, 8C, 8D, and 8E, a patterned media is manufactured in the similar manner to those in Comparative Example 1 except that the step of removing the resist residues shown in FIG. 7D is not performed.

In this case, the difference in resist residue thicknesses which is observed in FIG. 8C (that is, 37 nm in the left and 45 nm in the right) affected the step of etching the magnetic film in FIG. 8D. Consequently, it is observed that the magnetic films having a thickness of 8 nm are left without being etched in the right of FIG. 8E. Thus, the conventional method not involving the resist residue removal fails to uniformly etch the magnetic film.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method for manufacturing a magnetic recording media, comprising:
forming a magnetic film on a substrate and coating a resist on the magnetic film;
imprinting a stamper on the resist to transfer patterns of recesses and protrusions to the resist; and
removing the stamper and then performing ion milling to process the magnetic film with resist residues remained in recesses in the patterned resist to form magnetic patterns.

2. The method according to claim 1, wherein the stamper includes a plurality of areas having different occupation area rates of recesses.

3. The method according to claim 1, wherein, when the imprinting is performed using the stamper to transfer the patterns of recesses and protrusions to the resist, a minimum difference in a height of the resist patterns is larger in an area in the stamper where the occupation area rate of recesses is relatively low than in an area where the occupation area rate of recesses is relatively high.

4. The method according to claim 1, wherein the areas in the stamper having different occupation area rates of recesses correspond to a preamble portion, an address portion, a burst portion in a servo area, and a data area.

5. The method according to claim 1, wherein the depth of the recesses of the stamper is greater than a thickness of the resist prior to the imprinting.
